(19) United States
(12) Patent Application Publication
(10) Pub. No.: US 2025/0154013 A1
(43) Pub. Date: May 15, 2025

(54) METHOD OF PREPARING MXENE, MXENE PREPARED THEREBY, AND ELECTRODE FOR ELECTROCHEMICAL DEVICE INCLUDING SAME

(71) Applicant: KOREA INSTITUTE OF ENERGY RESEARCH, Daejeon (KR)

(72) Inventors: Sun Hwa YEON, Sejong-si (KR); Kyoung Hee SHIN, Daejeon (KR); Chang Soo JIN, Sejong-si (KR); Dong Ha KIM, Daejeon (KR); Se Kook PARK, Daejeon (KR); Seung Hae HWANG, Daejeon (KR); Dong Hee GUEON, Daejeon (KR); Yeon Ji CHOI, Changwon-si (KR); Dae Seon HONG, Daejeon (KR)

(73) Assignee: KOREA INSTITUTE OF ENERGY RESEARCH, Daejeon (KR)

(21) Appl. No.: 18/945,727

(22) Filed: Nov. 13, 2024

(30) Foreign Application Priority Data
Nov. 14, 2023 (KR) 10-2023-0157713

(51) Int. Cl. C01B 32/90

(52) U.S. Cl. CPC C01B 32/90; C01P 2002/72; C01P 2006/40

(57) ABSTRACT

Disclosed is a method of preparing MXene, by which the manufacturing costs are reduced, and the manufacturing steps are simplified. According to one aspect, provided is the method of preparing a MXene, the method including (S1) preparing a preliminary MXene by halogenating a MAX through a halogenation reaction using a halogen gas and (S2) preparing a MXene by reducing the preliminary MXene through a reduction reaction.

### CROSS REFERENCE TO RELATED APPLICATION

The present application claims priority to Korean Patent Application No. 10-2023-0157713, filed on Nov. 14, 2023 the entire contents of which is incorporated herein for all purposes by this reference.

### BACKGROUND OF THE DISCLOSURE

### Field of the Disclosure

The present disclosure relates to a method of preparing a MXene. More specifically, the present disclosure relates to a method of preparing a MXene, a MXene prepared thereby, and an electrode for an electrochemical device including the same.

### Description of the Related Art

Lithium-ion batteries are known as the best batteries in existence due to having high charge capacity and voltage level per unit weight and volume. Graphite with a crystalline two-dimensional (2D) structure is currently available as a negative electrode for lithium-ion batteries. When using graphite capable of intercalating lithium ions as a negative electrode, a maximum capacity of 372 mAh/g can be realized due to the LiC₆ structure.

However, there are limitations in the theoretical capacity of graphite, so the energy density of lithium-ion batteries is insufficient to meet the driving range requirements of currently available electric vehicles. With the growing demand for batteries with higher energy density, there has been a need to develop new negative electrode materials. In particular, intense development on 2D-structured high-capacity carbon for negative electrodes is in progress. As part thereof, new MXene structures in which electrical conductivity can be further improved and interlayer control is possible by adding metal atoms to carbon with the 2D layered structure have emerged and thus are being studied and developed as a next-generation electrode for secondary batteries.

Typically, in methods of preparing MXenes by removing A layers from MAX (Mₙ₊₁AXₙ; where M is a transition metal, A is any one element selected from Groups 12 to 16, X is a carbon or nitrogen atom, and n is in the range of 1 to 3), wet methods using solvents have been employed. For example, when using hydrogen fluoride (HF) as a solvent at high temperatures or room temperature, oxygen atoms or hydroxy groups on the surface of MXenes may react with fluorine so that the MAX are converted into Mₙ₊₁XₙTₓ (where T is an oxygen atom, a hydroxy group, or a fluorine atom, and x is the number of terminal groups). In this case, there have been problems in that the T groups of Mₙ₊₁XₙTₓ hinder lithium-ion intercalation/deintercalation.

In addition, there have been problems in that when applying MXenes prepared by wet methods to electrodes for electrochemical devices, the charging efficiency fails to be sufficiently improved, resulting in lifetime a shortened of such electrochemical devices.

In another aspect, when preparing MXenes by wet methods using solvents, post-processing processes become complex, resulting in problems with complicated manufacturing steps and long reaction times. This has resulted in additional issues, such as a significant increase in manufacturing costs during large-scale production.

### SUMMARY OF THE INVENTION

According to one aspect, the present disclosure aims to provide a method of preparing a MXene, the method being capable of reducing the effects of functional groups that hinder the intercalation/deintercalation of ion carriers, such as lithium ions, to a minimum.

According to another aspect, the present disclosure aims to provide a method of preparing a MXene, the method being capable of significantly reducing manufacturing costs by simplifying the manufacturing steps and post-processing operations thereof.

According to a further aspect, the present disclosure aims to provide a MXene prepared by the aforementioned method.

According to yet a further aspect, the present disclosure aims to provide an electrode for an electrochemical device, the electrode being capable of improving the performance of the electrochemical device.

According to still yet a further aspect, the present disclosure aims to provide an electrochemical device including the aforementioned electrode.

Objectives of the present disclosure are not limited to the objectives mentioned above. Other objectives and advantages of the present disclosure not mentioned will be clearly understood from the embodiments of the present disclosure below. In addition, it will be readily apparent that the objectives and advantages of the present disclosure will be realized by means described herein and combinations thereof.

According to a first aspect, the present disclosure provides a method of preparing a MXene, the method including: Step (S1) of preparing a preliminary MXene by halogenating a MAX through a halogenation reaction using a halogen gas; and Step (S2) of preparing a MXene by reducing the preliminary MXene through a reduction reaction.

According to a second aspect of the present disclosure, the halogen gas of the first aspect may include at least one gas selected from the group consisting of Cl₂, Br₂, I₂, TiCl₄, and F₂.

According to a third aspect of the present disclosure, the MAX of the first or second aspect may include a compound represented by General Formula 1 below.

Mₙ₊₁AXₙ [General Formula 1]

In General Formula 1, M is a transition metal, A is any one element selected from Groups 12 to 16, X is carbon or nitrogen, and n is in the range of 1 to 4. For example, n may be 1, 2, 3, or 4.

According to a fourth aspect of the present disclosure, in General Formula 1 of the third aspect, M may be any one selected from the group consisting of Sc, Lu, Ti, Zr, Hf, V, Nb, Ta, Cr, Mo, Mn, Hb, and Co, and A may be any one selected from the group consisting of Cd, Al, Ga, In, TI, Si, Ge, Sn, Pb, P, As, and S.

According to a fifth aspect of the present disclosure, Step (S1) of any one of the first to fourth aspects may include a step of performing at a temperature of 400° C. or higher and 1, 200° C. or lower for 5 minutes or more.

According to a sixth aspect of the present disclosure, Step (S1) of any one of the first to fifth aspects may include a step of performing at a temperature of 600° C. or higher and 1,000° C. or lower for 15 minutes or more.

According to a seventh aspect of the present disclosure, Step (S1) of any one of the first to sixth aspects may include a step of performing at a temperature of 700° C. or higher and 900° C. or lower for 25 minutes or more.

According to an eighth aspect of the present disclosure, Step (S2) of any one of the first to seventh aspects may include a step of performing at a temperature of 500° C. or higher and 600° C. or lower for 1 hour or more and 3 hours or less with at least one gas selected from the group consisting of H₂, Ar, N₂, and NH₃.

According to a ninth aspect, the present disclosure provides a MXene prepared by the method of any one of the first to eighth aspects.

According to a tenth aspect, the present disclosure provides an electrode for an electrochemical device of the ninth aspect.

The technical solutions to the problems above are not exhaustive of the features of the present disclosure. A variety of features of the present disclosure, and the resulting advantages and effects will be clearly understood in more detail with reference to the specific description below.

### BRIEF DESCRIPTION OF THE DRAWINGS

FIG. 1 is a schematic diagram illustrating a method of preparing a Mxene synthesized by a wet method.

FIG. 2A shows respective changes in X-ray diffraction (XRD) intensities of a MAX and a MXene in a method according to Example 1-1.

FIG. 2B shows respective changes in XRD intensities of a MAX and a MXene in a method according to Example 1-2.

FIG. 2C shows respective changes in XRD intensities of a MAX and a MXene in a method according to Example 1-3.

FIG. 3A shows respective changes in XRD intensities of a MAX and a MXene in a method according to Example 2-1.

FIG. 3B shows respective changes in XRD intensities of a MAX and a MXene in a method according to Example 2-2.

FIG. 3C shows respective changes in XRD intensities of a MAX and a MXene in a method according to Example 2-3.

### DETAILED DESCRIPTION

As used herein, unless the context clearly indicates otherwise, the singular forms are intended to include the plural forms.

When multiple embodiments are described herein, the effects of the present disclosure may be defined as including not only the effects resulting from each embodiment by itself but also effects resulting from the organic combination of each embodiment. For example, although first and second embodiments are each independently described herein, the effects of the present disclosure may also include effects resulting from the organic combination of these first and second embodiments, unless the context clearly indicates otherwise.

As used herein, a numerical range described with the use of the term “to” refers to a numerical range including the respective values listed before and after this term as the lower and upper limits. For example, a to b may mean a or more and b or less.

When a plurality of numerical values is disclosed herein as the upper and lower limits of any numerical range, the numerical range to be disclosed herein may be understood as a numerical range including any one value of the plurality of lower limit values and any one value of the plurality of upper limit values as the lower limit value and the upper limit value, respectively. For example, what is written as a or more or b or more and c or less or d or less may be understood to mean a or more and c or less, a or more and d or less, b or more and c or less, or b or more and d or less.

As used herein, terms such as “about” or “practically” refer to reasonable variations that do not significantly alter the final result. Such terms can be interpreted as including deviations of at least ±5% or at least ±10%, provided that the deviations do not distort or invalidate the meaning of the terms.

According to one aspect, the present disclosure provides a method of preparing a MXene, the method including: Step (S1) of preparing a preliminary MXene by halogenating a MAX through a halogenation reaction using a halogen gas; and Step (S2) of preparing a MXene by reducing the preliminary MXene through a reduction reaction.

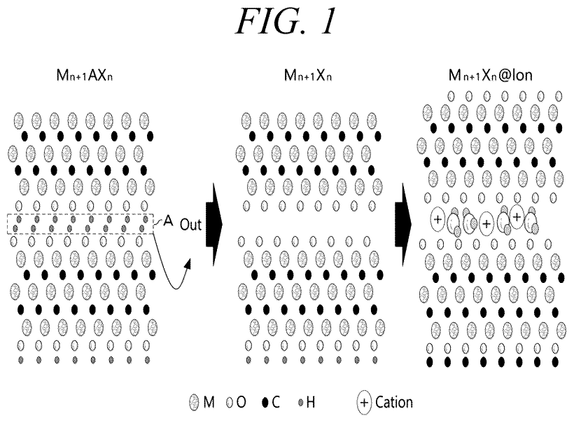

Hereinafter, the configuration of the present disclosure will be described in more detail with reference to FIG. 1.

FIG. 1 is a schematic diagram illustrating a method of preparing a Mxene synthesized by a wet method.

Referring to FIG. 1, typically, wet methods using solvents have been employed to remove A layers (for example, any one element from Groups 12 to 16) of MAX. For example, when using HF as a solvent at high temperatures or room temperature, oxygen atoms or hydroxy groups on the surface of MXenes may react with fluorine so that the MAX are converted into Mₙ₊₁XₙTₓ (where T is an oxygen atom, a hydroxy group, or a fluorine atom, and x is the number of terminal groups). In this case, the T groups of Mₙ₊₁XₙTₓ may hinder lithium-ion intercalation/deintercalation. In addition, there have been problems in that when applying MXenes prepared by wet methods to electrodes for electrochemical devices, the charging efficiency fails to be sufficiently improved, resulting in a shortened lifetime of such electrochemical devices. In another aspect, when preparing MXenes by wet methods, post-processing processes are involved, resulting in problems with complicated manufacturing steps and long reaction times. This has resulted in additional issues, such as a significant increase in manufacturing costs during large-scale production.

According to one aspect of the present disclosure, Step (S1) of preparing a preliminary MXene by halogenating a MAX through a halogenation reaction using a halogen gas and Step (S2) of preparing a MXene by reducing the preliminary MXene through a reduction reaction are combined. As a result, the method of preparing the MXene, which is capable of not only reducing the effects of functional groups that hinder the intercalation/deintercalation of ion carriers, such as lithium ions, to a minimum but also significantly reducing manufacturing costs by simplifying the manufacturing steps and post-processing operations thereof, may be provided. Specifically, unlike wet etching methods using common solvents, numerous post-processing operations are skipped out in this method due to the nature of dry processes involving halogen gas treatment without the use of solvents, resulting in a significant reduction in manufacturing costs during large-scale production.

According to another aspect of the present disclosure, a MXene is prepared by the method in which Step (S1) of preparing a preliminary MXene by halogenating a MAX through a halogenation reaction using a halogen gas and Step (S2) of preparing a MXene by reducing the preliminary MXene through a reduction reaction are combined. As a result, an electrochemical device with excellent charge/discharge cycle stability may be implemented when applying such a MXene prepared to an electrode of the electrochemical device.

the method of preparing the MXene, according to the present disclosure, includes Step (S1) of preparing a preliminary MXene by halogenating a MAX through a halogenation reaction using a halogen gas, in order to remove the A layer (for example any one element from groups 12 to 16) from the MAX.

As used herein, the “halogen gas” may be defined as a gas containing at least one halogen atom. For example, the pressure and temperature for the halogen gas may be adjusted with reference to a gas-specific phase diagram.

The halogen gas, according to the present disclosure, may effectively remove the A layer from the MAX without the use of solvents, such as HF. For example, the halogen gas may include at least one gas selected from the group consisting of Cl₂, Br₂, I₂, TiCl₄, and F₂. Specifically, the halogen gas may include Cl₂. In this case, Br₂ and I₂ are not gaseous at room temperature and thus may be formed into gas by varying a series of temperatures and/or pressures. According to some embodiments of the present disclosure, when using Cl₂ as the halogen gas, the Cl₂ used is gaseous, so only the A layer can be removed without changing the morphology of the precursor MAX, and the yields can be maximized because additional cleaning methods are not involved multiple times. Therefore, the removal efficiency of the A layer from the MAX can be further increased.

Unlike liquid halogen (for example, Br₂), which requires a long reaction time, the halogen gas, according to the present disclosure, is concentrated highly and thus can significantly shorten the halogenation reaction time. Specifically, when using liquid halogen, problems with longer reaction times of 12 hours or more may occur due to lower concentrations. On the other hand, when using the gaseous halogen gas according to the present disclosure, the halogenation reaction time may be significantly shortened, thus considerably shortening the preparation time of the MXene.

The MAX, according to the present disclosure, may include a compound represented by General Formula 1 below.

Mₙ₊₁AXₙ [General Formula 1]

In General Formula 1, M may be a transition metal, A may be any one element selected from Groups 12 to 16, X may be carbon or nitrogen, and n may be in the range of 1 to 4. For example, n may be 1, 2, 3, or 4.

Specifically, in General Formula 1, M may be any one selected from the group consisting of Sc, Lu, Ti, Zr, Hf, V, Nb, Ta, Cr, Mo, Mn, Hb, and Co, and A may be any one selected from the group consisting of Cd, Al, Ga, In, TI, Si, Ge, Sn, Pb, P, As, and S.

For example, the MAX is not particularly limited but may be Ti₂CdC, SC₂InC, Ti₂AlC, Ti₃AlC₂, Ti₂GaC, Ti₂InC, Ti₂TIC, V₂AlC, V₂GaC, Cr₂GaC, Ti₂AlN, Ti₂GaN, Ti₂InN, V₂GaN, Cr₂GaN, Ti₂GeC, Ti₂SnC, Ti₂PbC, V₂GeC, Cr₂AlC, Cr₂GeC, V₂PC, V₂AsC, Ti₂SC, Zr₂InC, Zr₂TlC, Nb₂AlC, Nb₂GaC, Nb₂InC, Mo₂GaC, Zr₂InN, Zr₂TlN, Zr₂SnC, Zr₂PbC, Nb₂SnC, Nb₂PC, Nb₂AsC, Zr₂SC, Nb₂SC, Hf₂InC, Hf₂TlC, Ta₂AlC, Ta₂GaC, Hf₂SnC, Hf₂PbC, Hf₂SnN, Hf₂SC, V₃AlC₂, Ti₃SiC₂, Ti₃GeC₂, Ti₃SnC₂, Ta₃AlC₂, Ti₄AlN₃, V₄AlC₃, Ti₄GaC₃, Ti₄SiC₃, Ti₄GeC₃, Nb₄AlC₃, Ta₄AlC₃, and the like.

In some embodiments of the present disclosure, Step (S1) may include a step of performing at a temperature of 400° C. or higher and 1,200° C. or lower for 5 minutes or more, specifically include a step of performing at a temperature of 600° C. or higher and 1,000° C. or lower for 15 minutes or more, and more specifically include a step of performing at a temperature of 700° C. or higher and 900° C. or lower for 25 minutes or more. For example, Step (S1) may include a step of performing for 5 minutes or more, 6 minutes or more, 7 minutes or more, 8 minutes or more, 10 minutes or more, 15 minutes or more, 20 minutes or more, or 25 minutes or more; and 26 minutes or less, 27 minutes or less, 28 minutes or less, 29 minutes or less, or 30 minutes or less at a temperature of 400° C. or higher, 450° C. or higher, 500° C. or higher, 550° C. or higher, 600° C. or higher, 650° C. or higher, 700° C. or higher, 750° C. or higher, 780° C. or higher, 790° C. or higher, or 800° C. or higher; and 810° C. or lower, 820° C. or lower, 850° C. or lower, 900° C. or lower, 950° C. or lower, 1,000° C. or lower, 1, 100° C. or lower, or 1,200° C. or lower. The reaction time and reaction temperature of Step (S1) are adjusted to fall within the above numerical ranges, thereby making the crystalline phase corresponding to the MAX disappear to further increase the purity of the MXene.

The method of preparing the MXene, according to the present disclosure, includes Step (S2) of preparing a MXene by reducing the preliminary MXene through a reduction reaction, in order to remove residues of the halogen gas from the preliminary MXene.

In some embodiments of the present disclosure, Step (S2) may include performing at a temperature of 500° C. or higher and 700° C. or lower for 1 hour or more and 3 hours or less with at least one gas selected from the group consisting of H₂, Ar, N₂, and NH₃, specifically, may include a step of performing the reduction reaction to reduce the preliminary MAX under a hydrogen (H₂) atmosphere. Specifically, Step (S2) may include performing at a temperature of 500° C. or higher, 510° C. or higher, 520° C. or higher, 530° C. or higher, 540° C. or higher, 550° C. or higher, 560° C. or higher, 570° C. or higher, 580° C. or higher, 590° C. or higher, or 600° C. or higher; and 610° C. or lower, 620° C. or lower, 630° C. or lower, 640° C. or lower, 650° C. or lower, 660° C. or lower, 670° C. or lower, 680° C. or lower, 690° C. or lower, or 700° C. or lower for 1 hour or more, 1.5 hours or more, 1.8 hours or more, or 2.0 hours or more; and 2.2 hours or less, 2.3 hours or less, 2.4 hours or less, or 2.5 hours or less. According to some embodiments of the present disclosure, the reaction time and reaction temperature of Step (S2) are adjusted to fall within the above numerical ranges, thereby effectively extracting the residues of the halogen from the preliminary MXene to allow the intercalation/deintercalation of ion carriers, such as lithium ions, to be well-performed when applying the MXene to an electrode for an electrochemical device.

According to another aspect, the present disclosure provides a MXene prepared by the aforementioned method according to some embodiments.

For example, the MXene is not particularly limited to those in powder form but may specifically have a median particle size (D₅₀) of 20 nm or greater and 200 μm or smaller, which is specifically in the range of 50 to 100 nm or 100 to 200 μm.

According to a further aspect, the present disclosure provides an electrode for an electrochemical device, the electrode including the aforementioned MXene according to some embodiments.

The electrochemical device, according to the present disclosure, is not particularly limited and may be any device causing electrochemical reactions. Specifically, the electrochemical device may be a lithium-ion battery, a lithium-ion capacitor, or the like.

According to some embodiments of the present disclosure, when applying the MXene to the electrode for the electrochemical device, an electrochemical device with excellent charge/discharge cycle stability can be implemented.

Hereinafter, exemplary examples of the present disclosure will be described in detail so that those skilled in the art can easily carry out the present disclosure. However, the following examples are only examples, and the scope of the present disclosure is not limited thereto.

### Preparation Example 1: Method of Preparing MXene

### <Examples 1-1 to 1-3: Method of Preparing MXene (Ti₂C) from MAX (Ti₂AlC)

Step of Treating MAX (Ti₂AlC) with Halogen Gas:

Respective halogenation reactions were performed on a MAX (Ti₂AlC) using chlorine gas (Cl₂) at a temperature of about 800° C. for about 8 minutes (Example 1-1), about 10 minutes (Example 1-2), and about 15 minutes (Example 1-3), thereby preparing each preliminary MXene free of the aluminum (Al) layer.

Step of Removing Residues of Halogen from Preliminary MXene:

To remove residues of chlorine gas from the surface of the preliminary MXene, a reduction reaction was performed under a hydrogen atmosphere at a temperature of about 600° C. for about 2 hours, thereby ultimately preparing each MXene (Ti₂C).

### <Examples 2-1 to 2-3: Method of Preparing MXene (Ti₃C₂) from MAX (Ti₃AlC₂)

Step of Treating MAX (Ti₃AlC₂) with Halogen Gas:

Respective halogenation reactions were performed on a MAX (Ti₃AlC₂) using chlorine gas (Cl₂) at a temperature of about 800° C. for about 5 minutes (Example 2-1), about 15 minutes (Example 2-2), and about 25 minutes (Example 2-3), thereby preparing each preliminary MXene free of the aluminum (Al) layer.

Step of Removing Residues of Halogen from Preliminary MXene:

To remove residues of chlorine gas from the surface of the preliminary MXene, a reduction reaction was performed under a hydrogen atmosphere at a temperature of about 600° C. for about 2 hours, thereby ultimately preparing each MXene (Ti₃C₂).

### Experimental Example: X-Ray Diffraction (XRD) Analysis to Confirm Conversion of MAX into MXene

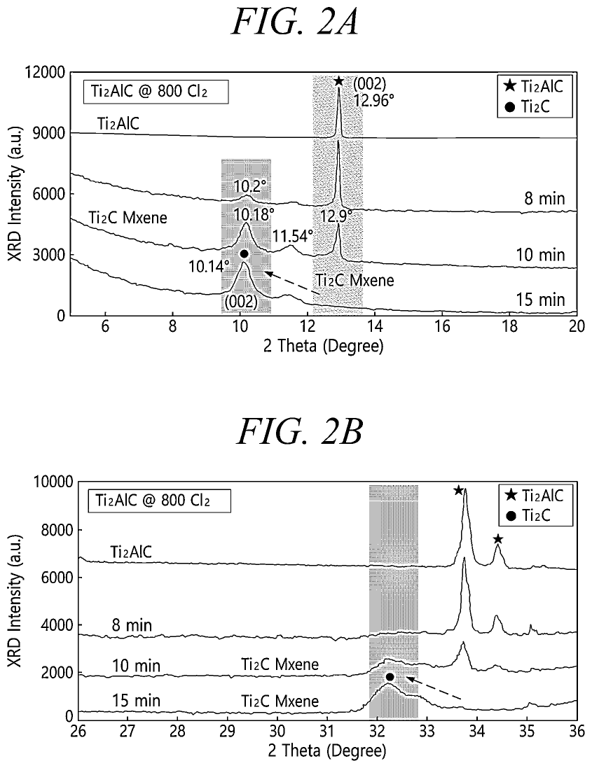

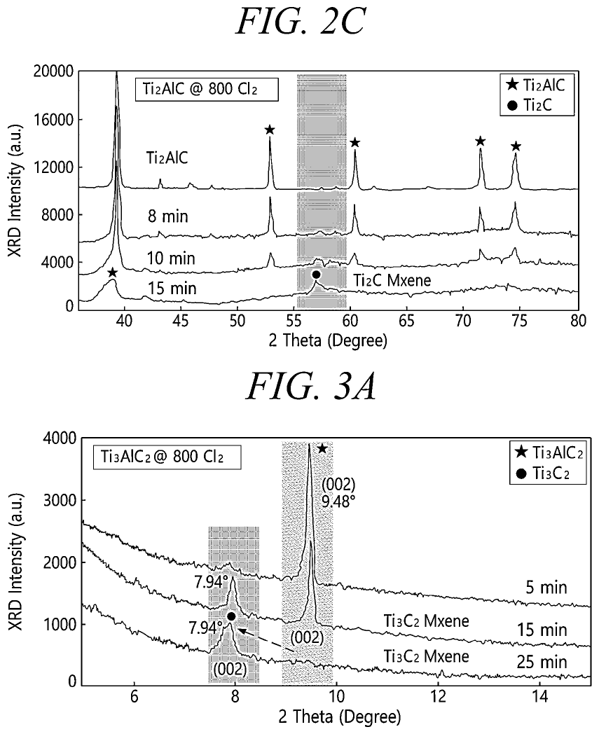

FIG. 2A shows respective changes in XRD intensities of the MAX and the MXene in the method according to Example 1-1. FIG. 2B shows respective changes in XRD intensities of the MAX and the MXene in the method according to Example 1-2. FIG. 2C shows respective changes in XRD intensities of the MAX and the MXene in the method according to Example 1-3.

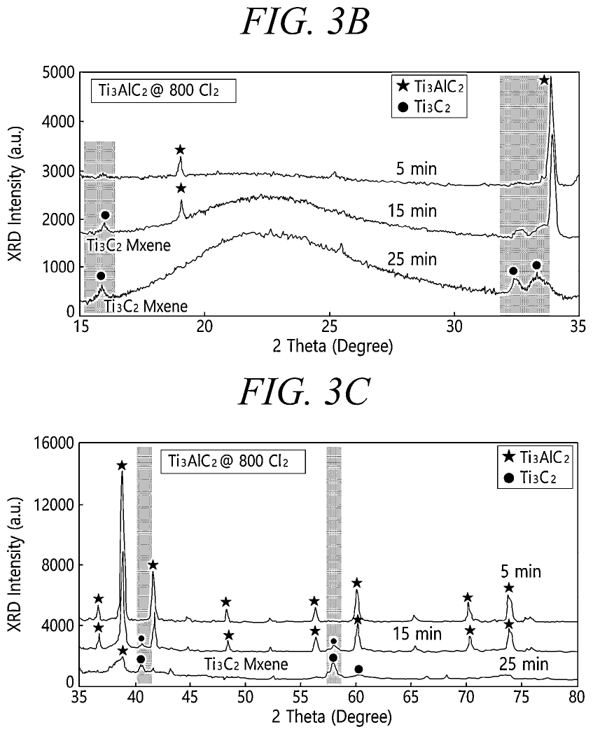

FIG. 3A shows respective changes in XRD intensities of the MAX and the MXene in the method according to Example 2-1. FIG. 3B shows respective changes in XRD intensities of the MAX and the MXene in a method according to Example 2-2. FIG. 3C shows respective changes in XRD intensities of the MAX and the MXene in a method according to Example 2-3. Specifically, a SmartLab High Temp/Rigaku analyzer purchased from Rigaku was used for the XRD analysis under the following analysis conditions: 2θ=5° to 90°, and 2° C./min. In this case, the technical specification featuring the SmartLab High Temp/Rigaku analyzer is as follows: 9 KW (45 kV, 200 mA), Cu (1.5406 Å-alpha 1 Optics, 1D-detector, React-X, and ASC-10.

Referring to FIGS. 2A to 2C, in the case of the method according to Example 1-3, where the halogenation reaction was performed for about 15 minutes in a 2θ range of 0° to 20°, the (002) peak at 12.96° disappeared, and a peak shifted to 10.14° was shown while the crystalline peak disappeared, unlike in the case of the methods according to Examples 1-1 and 1-2, where the reaction time was relatively short.

Furthermore, when the 20 exceeds 20°, the crystalline peak of the MAX in the case of the method according to Example 1-3 was shown to disappear during the conversion process into the MXene.

Referring to FIGS. 3A to 3C, in the case of the method according to Example 2-3, where the halogenation reaction was performed for about 25 minutes, the (002) peak at 9.48° disappeared, and a peak shifted to 7.94° was shown, unlike in the case of the methods according to Examples 2-1 and 2-2, where the reaction time was relatively short.

Furthermore, when the 20 exceeds 20°, the crystalline peak of the MAX in the case of the method according to Example 2-3 was shown to disappear during the conversion process into the MXene.

Although the preferred embodiments of the present disclosure have been described in detail hereinabove, the scope of the present disclosure is not limited thereto. This means that several modifications and alternatives made by those skilled in the art using a basic concept of the present disclosure as defined in the appended claims also fall within the scope of the present disclosure.

What is claimed is:

1. A method of preparing a MXene, the method comprising:
(S1) preparing a preliminary MXene by halogenating a MAX through a halogenation reaction using a halogen gas; and
(S2) preparing a MXene by reducing the preliminary MXene through a reduction reaction.

2. The method of claim 1, wherein the halogen gas comprises at least one gas selected from the group consisting of Cl₂, Br₂, I₂, TiCl₄, and F₂.

3. The method of claim 1, wherein the MAX comprises a compound represented by General Formula 1 below,
Mₙ₊₁AXₙ [General Formula 1]
where in General Formula 1, M is a transition metal, A is any one element selected from Groups 12 to 16, X is carbon or nitrogen, and n is in a range of 1 to 4.

4. The method of claim 3, wherein in General Formula 1, M is any one selected from the group consisting of Sc, Lu, Ti, Zr, Hf, V, Nb, Ta, Cr, Mo, Mn, Hb, and Co, and
A is any one selected from the group consisting of Cd, Al, Ga, In, TI, Si, Ge, Sn, Pb, P, As, and S.

5. The method of claim 1, wherein the (S1) preparing comprises a step of performing at a temperature of 400° C. or higher and 1,200° C. or lower for 5 minutes or more.

6. The method of claim 1, wherein the (S1) preparing comprises a step of performing at a temperature of 600° C. or higher and 1,000° C. or lower for 15 minutes or more.

7. The method of claim 1, wherein the (S1) preparing comprises a step of performing at a temperature of 700° C. or higher and 900° C. or lower for 25 minutes or more.

8. The method of claim 1, wherein the (S2) preparing comprises a step of performing at a temperature of 500° C. or higher and 600° C. or lower for 1 hour or more and 3 hours or less, with at least one gas selected from the group consisting of H₂, Ar, N₂, and NH₃.

9. A MXene prepared by the method of claim 1.

10. An electrode for an electrochemical device, the electrode comprising the MXene of claim 9.
